(19) United States
(12) Patent Application Publication
(10) Pub. No.: US 2021/0116002 A1
(43) Pub. Date: Apr. 22, 2021

(54) DEVICE FOR CONNECTING SECURING LINES AND METHODS FOR USING THE SAME

(71) Applicant: Joel B. Coulter, Visalia, CA (US)

(72) Inventor: Joel B. Coulter, Visalia, CA (US)

(21) Appl. No.: 17/071,938

(22) Filed: Oct. 15, 2020

Related U.S. Application Data
(60) Provisional application No. 62/915,813, filed on Oct. 16, 2019.

(51) Int. Cl. F16G 11/14; F16G 11/10

(52) U.S. Cl. CPC F16G 11/14; F16G 11/10

(57) ABSTRACT

The present invention provides methods and apparatus for connecting one or more securing lines. The devices may comprise a body having a central passage and a plurality of fastening members. The devices may be operable to quickly and releasably attach to a point or to multiple points on one or more securing lines without the need to tie a knot in or with the line. The devices may connect to a point on the securing line by passing the line through the central passage and then engaging the line with a fastening member. The securing lines may be easily tightened with a minimum of motions by pulling the line through the central passage until the line is under tension, and then sliding the taut line into a fastening member, the fastening member acting to prevent loosening of the line.

### PRIORITY CLAIM

This application is a non-provisional of and claims the benefit of U.S. Provisional Patent Application No. 62/915,813 filed on Oct. 16, 2019 which is incorporated herein by this reference in its entirety.

### BACKGROUND

The present invention relates generally to devices for connecting securing lines, and more specifically to a device for quickly and releasably connecting multiple securing lines, or the ends of multiple securing lines, or connecting multiple locations on a single line, to a single location or to multiple locations without the need to tie the line(s) in knots, and methods for using the same.

There are endless situations in which one or more securing lines need to be connected at a particular location in order to maintain the tension or location of the line(s). Examples include connecting ropes around a load in the back of a truck, connecting lines around or over a load on a pallet, connecting lines on a sailboat, connecting the line(s) of a hammock or clothes line around a tree, securing gear to a backpack or a saddle, and many other similar situations where a load needs to be secured via one or more lines.

Conventional methods for accomplishing the connection of securing lines include the time-tested practice of tying the line(s) in a knot—either to each other or in combination with a connector such as a hook, carabiner, or cleat—or permanently attaching some type of connector to the end of a line (e.g., a bungee cord with a hook at each end). However, effectively tying securing lines in knots is time consuming, especially when there are several lines or ends to be tied together. Also, in many situations, tying multiple lines together requires the person tying the knot(s) to have some level of skill in selecting and executing the appropriate type of knot for that particular situation. Further, tying or permanently attaching a connector to the end of a line limits the utility of that line. The connector adds to the weight of the line and may make the line more cumbersome to collect and store, and the connector is only effective in securing the very end of the line. In many situations a line may be longer than necessary, calling for the line to be secured at some midpoint thereof, which would again require the tying of a knot despite the presence of the connector.

Therefore, what is needed is a device for quickly connecting the ends or midpoints of one or more securing lines in a manner which does not require the tying of a knot or permanently attaching the device to the line(s).

### SUMMARY

The present invention provides devices for connecting one or more securing lines. Embodiments of the device may comprise a body having a central passage and a plurality of fastening members. The connector devices may be operable to quickly and releasably attach to a point on one or more securing lines without the need to tie a knot in or with the line. The devices may connect to a point on the securing line by passing the line through the central passage and then engaging the line with one of the fastening members. The securing lines may be easily tightened with a minimum of motions by pulling the line through the central passage until the line is under tension, and then sliding the taut line into a fastening member, the fastening member acting to prevent loosening of the line (i.e., longitudinal movement in a direction which gives slack to the line), but allow the line to be further tightened (i.e., longitudinal movement which increases tension in the line) while still engaged with the fastening member.

The connector devices of the present invention may therefore be used to connect and provide tension to the lines used to secure a load (e.g., boxes, furniture, bags, sacks, and the like) in place (e.g., in the back of a truck, on top of a vehicle roof, on a pallet, on a backpack, on a saddle, on the deck of a vessel, the ends of a hammock line or clothes line wrapped around a tree or other support, and the like). Embodiments of the present invention may be operable to connect any type of line which may be utilized to secure a load in place (e.g., ropes, cords, string, bungee cables, chains, straps, leather thongs, and the like).

Embodiments of the present invention may connect to a securing line at any point or at multiple points along the length of the line, and/or may connect multiple lines together. Thus, securing lines which are longer than necessary for the job may be utilized by engaging the line with a fastening member of the present invention at a point in the line which will provide the appropriate amount of tension for the job, and without the need to tie the line into a complicated and/or time-consuming knot. Embodiments of the present invention may be operable to connect multiple securing lines coming from multiple directions around a load, to connect one or more of the ends of such lines, to connect multiple points on one or more lines which may be wrapped around a load or a supporting structure, or a combination thereof.

Embodiments of the connectors of the present invention may comprise a body having a central passage and at least one fastening member. In some embodiments, the body may comprise at least one of a ring shape, a disc shape, a puck shape, a polygonal shape, a cylindrical shape, spool-like shape, a cubic shape, a cubic rectangular shape, and the like. In some embodiments, the body may comprise a low profile (e.g., a width substantially greater than a height) when viewed from the side (e.g., an edge-on view). In other embodiments a height and a width of the body when viewed from the side may be substantially similar. In some embodiments, a corner or edge of the body which may come in contact with a securing line may comprise at least one of a bevel and a rounded shape in order to reduce friction from contact with the line as it is pulled around or along the corner or edge of the body.

The central passage of embodiments of the connectors of the present invention may comprise an opening traversing the body at a substantially central location of the body, providing a passage for the one or more securing lines to pass through prior to engaging with a fastening member. By first passing a line through the central passage, the orientation of the line (e.g., the angle or position of the line with respect to the angle or position of the body of the connector) may be optimized for engagement the device. In some embodiments, a line may be passed in an initial direction through the central passage, the end of the line then being turned radially out toward an outer edge of the body, and finally turned back into a direction opposite of the initial direction for engagement with a fastening member. The tension in a line may thereby pull on the body at a more central location (i.e., at the central passage rather than at the outer edge of the body), reducing the tendency of the body to twist due to that tension. Reduction of twisting of the body may prevent tangling of a plurality of securing lines engaged with the connector, as well as preventing unintentional disengagement or slackening of such lines.

In some embodiments, the body may comprise a disc shape (e.g., a generally flat shape with two opposing faces) and the central passage may traverse the body from the center of one face to the center of the opposing face. In some embodiments, the central passage may comprise at least one of a circular shape, an ovular shape, a triangular shape, square shape, hexagonal shape, an octagonal shape, another polygonal shape, and the like. In some embodiments, the corners of the polygonal shape of the central passage may be rounded. In some embodiments, an edge of the central passage be beveled. In other embodiments, an edge of the central passage may be rounded.

In some embodiments, the central passage may comprise an indentation (e.g., a notch) in a perimeter thereof, the indentation positioned radially in line with the at least one fastening member, such that a line passing through the central passage and secured in the fastening member is prevented from moving around the perimeter of the central passage. A line secured in the indentation may thus be prevented from sliding along the sharp edges of a slot of the fastening member, reducing wear on the line and on the fastening member. In some embodiments, the at least one fastening member may comprise a plurality of fastening members positioned circumferentially evenly about a perimeter of the body, and the central passage may comprise a plurality of indentations equal in number to the plurality of fastening members, each of the indentations being positioned radially in line with a fastening member. In some embodiments, the plurality of fastening members may comprise four fastening members, arranged evenly about the perimeter of the body (e.g., one fastening member per 90 degrees of arc).

In other embodiments, the central passage may comprise a polygonal shape wherein a corner of the polygonal shape is positioned radially in line with the at least one fastening member. In some embodiments, the at least one fastening member may comprise a plurality of fastening members equal in number to the corners of the polygonal shape of the central passage, each of the corners being positioned radially in line with a fastening member. In yet other embodiments, each fastening member may be positioned radially in line with a side of the polygonal shape of the central passage (e.g., four fastening members, each positioned radially in line with a different side of the octagonally shaped central passage).

The at least one fastening member may comprise a mechanism for engaging one or more securing lines. The fastening member may be operable to prevent longitudinal movement of the one or more securing lines, such that tension in the line(s) is maintained. In some embodiments, the fastening member may be operable to prevent longitudinal movement of the one or more lines in a first direction (i.e., preventing loosening of the securing line(s) around a load) while allowing longitudinal movement in a second direction (i.e., allowing the line(s) to be further tightened around the load), the second direction being opposite of the first direction.

In some embodiments, the fastening member may comprise a fastening slot, the fastening slot being defined by a plurality of opposing securing edges. In some embodiments, a width of said primary fastening slot is complementary to a diameter of said one or more securing lines. In some embodiments, each of said securing edges is shaped to resist movement of said one or more securing lines in a first longitudinal direction, and to allow for movement of said one or more securing lines in a second longitudinal direction. In some embodiments, each of said securing edges may act as a barb to resist movement of said one or more securing lines in a first longitudinal direction, the barbs offering a relatively sharp point angled diagonally with respect to the central axis of the securing line and in opposition to the first longitudinal direction. As the securing line is pulled in the first longitudinal direction, the securing edges may thus be pulled inward toward a center line of the fastening slot, reducing the width of the fastening slot and tightening the securing edges' hold on the line. Conversely, pulling the securing line in the second longitudinal direction (opposite the first longitudinal direction) may push the securing edges (i.e., barbs) further apart, increasing the width of the fastening slot and decreasing the friction between the line and the securing edges.

In some embodiments, each of said securing edges comprises a first side wall substantially perpendicular to an axis of said one or more securing lines and a second side wall not perpendicular to said axis, said first and second sidewalls defining an angle of the securing edge. The angle of the securing edge may thus be sharp in relation to an outer surface of the engaged securing line on one side, and dull on the other side in relation to the outer surface. The securing edge may thus provide substantially greater friction against movement of the line in a first longitudinal direction (i.e., movement of the line toward the securing edge from the side of the first sidewall) than in a second, opposite longitudinal direction (i.e., movement of the line toward the side of the second sidewall).

In some embodiments, the at least one fastening member may comprise a primary fastening slot and at least one secondary fastening slot branching off from the primary fastening slot. A user may thus be able to engage a securing line with the primary fastening slot (e.g., slide the line into the primary fastening slot) and then adjust a position of the line to engage it with the at least one secondary fastening slot (e.g., slide the line from the primary fastening slot into the at least one secondary fastening slot). The at least one secondary fastening slot may thus increase the capacity of the fastening member for engaging with securing lines (e.g., enabling engagement with a greater number of lines).

In some embodiments, the at least one secondary fastening slot may comprise a width substantially smaller than a width of the primary fastening slot. The at least one secondary fastening slot may thus be operable to secure a line having a diameter which is too small to be secured by the primary fastening slot. A user may thus be able to slide a line into the primary fastening slot, determine whether the line has a diameter which allows it to be secured in the primary fastening slot, and if the line is too thin, easily slide the line into the at least one secondary fastening slot where the line may be secured.

In some embodiments, the at least one fastening slot may comprise a plurality of secondary fastening slots. In some embodiments, the plurality of secondary fastening slots may be arranged on opposite sides of the primary fastening slot, extending in substantially opposite directions from the primary fastening slot. In other embodiments, a plurality of secondary fastening slots may be arranged on the same side of the primary fastening slot. In some embodiments, each side of the primary fastening slot may comprise a plurality of secondary fastening slots.

The at least one secondary fastening slot may comprise a plurality of opposing secondary securing edges. In some embodiments, a first secondary securing edge of said plurality of secondary securing edges may be shaped to resist movement of said one or more securing lines in a first longitudinal direction, and to allow for movement of said one or more securing lines in a second longitudinal direction. In some embodiments, at least one of said plurality of secondary securing edges may act as a barb to resist movement of said one or more securing lines in a first longitudinal direction, the barb offering a relatively sharp point angled diagonally with respect to the central axis of the securing line and in opposition to the first longitudinal direction. The second secondary securing edge may comprise any shape which provides a surface for opposing the force applied to the securing line by the first secondary securing edge (e.g., a substantially flat surface, a gently curving surface, or a barbed shape opposing the barb of the first second securing edge).

As the securing line is pulled in the first longitudinal direction, the secondary securing edge may thus be pulled inward toward a center line of the secondary fastening slot, reducing the width of the secondary fastening slot and tightening the securing edge's hold on the line. Conversely, pulling the securing line in the second longitudinal direction (opposite the first longitudinal direction) may push the securing edge away from the centerline of the secondary fastening slot, increasing the width of the secondary fastening slot and decreasing the friction between the line and the secondary securing edge(s).

In some embodiments, at least one of said secondary securing edges comprises a first side wall substantially perpendicular to an axis of said one or more securing lines and a second side wall not perpendicular to said axis, said first and second sidewalls defining an angle of the securing edge. The angle of the securing edge may thus be sharp in relation to an outer surface of the engaged securing line on one side, and dull on the other side in relation to the outer surface. The securing edge may thus provide substantially greater friction against movement of the line in a first longitudinal direction (i.e., movement of the line toward the securing edge from the side of the first sidewall) than in a second, opposite longitudinal direction (i.e., movement of the line toward the side of the second sidewall).

A method of using the present invention may comprise the steps of: providing a device for connecting one or more securing lines, the device comprising a body having a central passage and a plurality of fastening members arranged around a perimeter of the body; passing a first securing line through the central passage; and engaging the first securing line with a fastening member of the plurality of fastening members. In some embodiments, the method may further comprise the steps of: passing a second securing line through the central passage; and engaging the second securing line with a fastening member of the plurality of fastening members.

In another embodiment, a method of using the present invention may comprise the steps of: passing a securing line through the central passage; wrapping the line around a separate securing member (e.g., a securing hook or loop in the bed of a truck, a board of a pallet, a cleat or loop on a boat deck, a loop on a saddle or backpack, and the like); passing the line back through the central passage; and engaging the line with a fastening member of the plurality of fastening members.

In another embodiment, a method of using the present invention may comprise the steps of: pulling a midpoint of a securing line through the central passage (i.e., pulling a midpoint of the line from a first side of the central passage into a loop on the second side of the central passage); wrapping a midpoint of the line around a fastening member of the plurality of fastening members; passing an end of the line though a separate securing member (e.g., a securing hook or loop in the bed of a truck, a board of a pallet, a cleat or loop on a boat deck, a loop on a saddle or backpack, and the like); passing that end of the line through the central passage; pulling on the line to create tension in the line; and engaging the line with a fastening member of the plurality of fastening members. In some embodiments, the method may further comprise the step of wrapping the end of the securing line around to engage with another fastening member of the plurality of fastening members. In some embodiments, the step of wrapping the line around a fastening member may comprise wrapping the line around a first fastening member opposite from the separate securing member (i.e., the fastening member closest to the load being secured). In some embodiments, the step of engaging the line with a fastening member may comprise engaging the line with a second fastening member, the second fastening member being closest to the separate securing member. In some embodiments, the step of wrapping the end of the securing line around to engage with a another fastening member may comprise engaging the line with the first fastening member.

### BRIEF DESCRIPTION OF THE FIGURES

The detailed description of some embodiments of the present invention is made below with reference to the accompanying figures, wherein like numerals represent corresponding parts of the figures.

FIG. 1 shows a perspective view of a device for connecting one or more securing lines, according to an embodiment of the present invention.

FIG. 2 shows a top-down view of a device for connecting one or more securing lines, according to an embodiment of the present invention.

FIG. 3 shows a side view of a device for connecting one or more securing lines, according to an embodiment of the present invention.

FIGS. 4A-4C show perspective views of a device for connecting one or more securing lines, according to an embodiment of the present invention.

FIGS. 5A-5B show perspective views of a method for using a device for connecting one or more securing lines, according to an embodiment of the present invention.

FIGS. 6A-6D show perspective views of a method for using a device for connecting one or more securing lines, according to an embodiment of the present invention.

FIGS. 7A-7C show a perspective view, a top-down view, and a side view, respectively, of a device for connecting one or more securing lines, according to an embodiment of the present invention.

FIGS. 8A-8C show a top-down view, side view, and perspective view, respectively, of a device for connecting one or more securing lines, according to an embodiment of the present invention.

FIGS. 9A-9C show a perspective view, a top-down view, and a side view, respectively, of a device for connecting one or more securing lines, according to an embodiment of the present invention.

FIGS. 10A-10D show a perspective view, a top-down view, and two side views, respectively, of a device for connecting one or more securing lines, according to an embodiment of the present invention.

FIGS. 11A-11C show a perspective view, a top-down view, and a side view, respectively, of a device for connecting one or more securing lines, according to an embodiment of the present invention.

FIGS. 12A-12C show a perspective view, a top-down view, and a side view, respectively, of a device for connecting one or more securing lines, according to an embodiment of the present invention.

FIGS. 13A-13B show a top-down view, and a side view, respectively, of a device for connecting one or more securing lines, according to an embodiment of the present invention.

FIGS. 14A-14C show a perspective view, a top-down view, and a side view, respectively, of a device for connecting one or more securing lines, according to an embodiment of the present invention.

FIGS. 15A-15C show a perspective view, a top-down view, and a side view, respectively, of a device for connecting one or more securing lines, according to an embodiment of the present invention.

FIGS. 16A-16C show a perspective view, a top-down view, and a side view, respectively, of a device for connecting one or more securing lines, according to an embodiment of the present invention.

FIGS. 17A-17C show a perspective view, a top-down view, and a side view, respectively, of a device for connecting one or more securing lines, according to an embodiment of the present invention.

### DETAILED DESCRIPTION

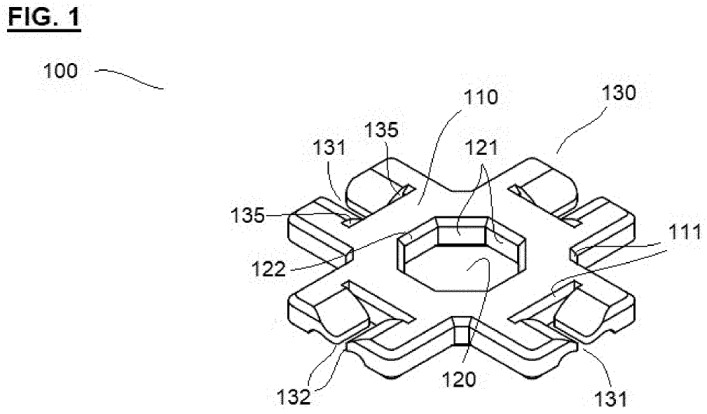

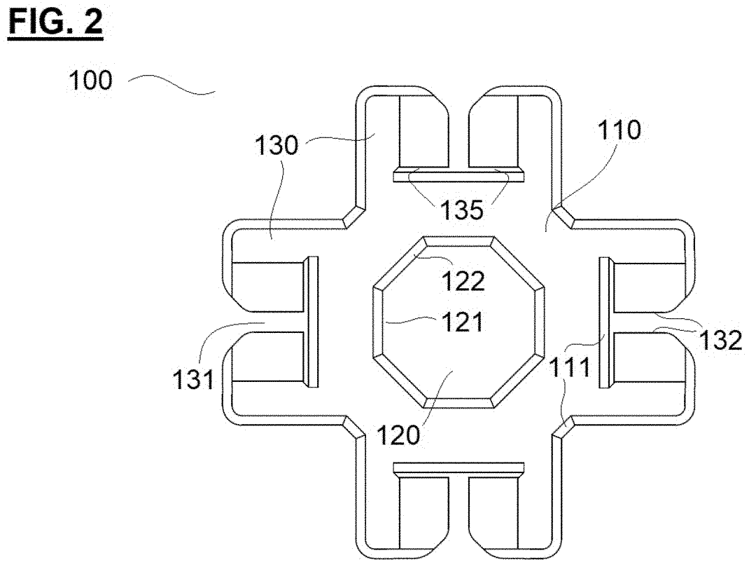

By way of example, and referring to FIGS. 1-3, one embodiment of the present invention comprises a device 100 for connecting one or more securing lines 101 (not shown). Embodiments of the present invention may comprise a body 110 having a central passage 120 and a plurality of fastening members 130. The body 110 may comprise a substantially polygonal shape (e.g., an octagonal shape) having a low profile (e.g., a width of the body being substantially greater than a height of the body) when viewed from the side. Edges of the body 110 which may come in contact with a securing line may comprise a bevel 111 in order to reduce friction from contact with the line as it is pulled around or along the edges.

The central passage 120 may comprise an opening traversing the body 110 at a substantially central location of the body 110, providing a passage for the one or more securing lines 101 (not shown) to pass through prior to engaging with a fastening member 130. By first passing a securing line 101 through the central passage 120, the orientation of the line 101 (e.g., the angle or position of the line 101 with respect to the angle or position of the body 110) may be optimized for engagement a fastening member 130. The central passage 120 may be circular, or may comprise a substantially polygonal shape (e.g., an octagonal shape, as shown in FIGS. 1-6) complementary with the substantially polygonal shape of the body 110, such that sides 121 of the central passage 120 may be parallel with a side of the body 110. Each fastening member 130 of the plurality of fastening members may thus be radially aligned with a side 121 of the central passage 120. The edges of each side 121 of the central passage 120 may comprise a bevel 122 in order to reduce friction from contact with a securing line 101 as it is pulled around or along the edges of the central passage 120.

In the illustrated exemplary embodiment of FIGS. 1-3, the plurality of fastening members 130 may comprise four fastening members, arranged evenly about an outer perimeter of the body 110 (e.g., one fastening member per 90 degrees of arc). Each fastening member 130 may comprise a mechanism for engaging the one or more securing lines 101 (not shown). Each fastening member 130 may be operable to prevent longitudinal movement of the one or more securing lines 101, such that tension in the line(s) 101 is maintained. Each fastening member 130 may be operable to prevent longitudinal movement of the one or more lines 101 in a first direction (i.e., preventing loosening of the securing line(s) 101 around a load) while allowing longitudinal movement in a second direction (i.e., allowing the line(s) 101 to be further tightened around the load), the second direction being opposite of the first direction.

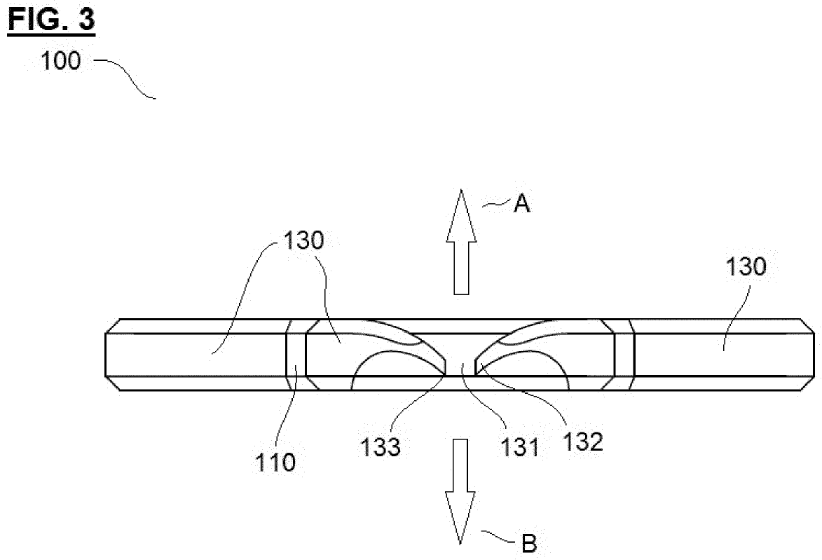

In the illustrated exemplary embodiment of FIGS. 1-3, each fastening member 130 may comprise a primary fastening slot 131, the primary fastening slot 131 being defined by a plurality of opposing securing edges 132 and may have a width complementary to (i.e., slightly smaller than) a diameter of a line of the one or more securing lines 101 (not shown). As best seen in FIG. 3, each of said securing edges 132 may be shaped to resist movement of said one or more securing lines 101 in the first longitudinal direction, and to allow for movement of said one or more securing lines 101 in the second longitudinal direction. The securing edges 132 may each comprise a barb shape having a relatively sharp point 133 angled diagonally with respect to a central axis of the securing line 101 and in opposition to the first longitudinal direction. As the securing line 101 is pulled in the first longitudinal direction A, the securing edges 132 may thus be pulled inward toward a center line of the fastening slot 131, reducing the width of the primary fastening slot 131 and tightening the securing edges' 132 hold on the line, thereby preventing the line from being disengaged from or pulled through fastening member 130. Conversely, pulling the securing line 101 in the second longitudinal direction B (opposite the first longitudinal direction A) may push the securing edges 132 further apart, increasing the width of the primary fastening slot 131 and decreasing the friction between the line 101 and the securing edges 132, allowing the line to be disengaged, pulled through or removed from the fastening member 130.

Each fastening member 130 may further comprise a plurality of secondary fastening slots 135 branching off from the primary fastening slot 131, the plurality of secondary fastening slots 135 being arranged on opposite sides of the primary fastening slot 131, extending from the primary fastening slot 131 in substantially opposite directions. Each of the secondary fastening slots 135 may comprise a width substantially smaller than a width of the primary fastening slot 131. Each of the secondary fastening slots 135 may thus be operable to secure a line having a diameter which is too small to be properly secured within the primary fastening slot 131. A user may thus be able to engage a securing line with the primary fastening slot 131 and if the width of the line is too small to be secured therein, the user may easily adjust the line to engage it with a secondary fastening slot 135 (e.g., slide the line from the primary fastening slot 131 to the secondary fastening slot 135).

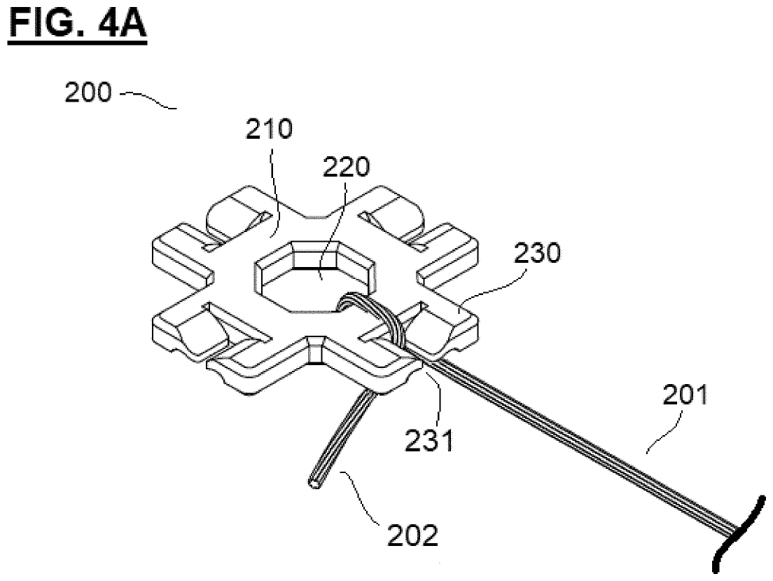

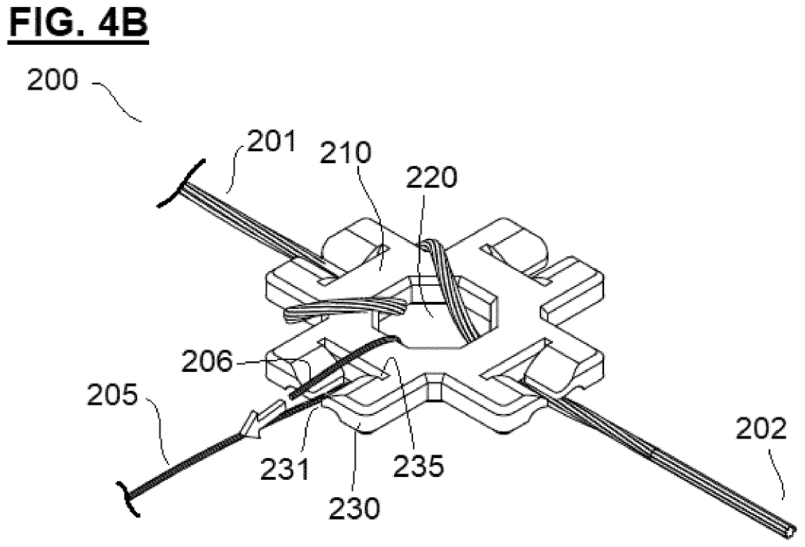

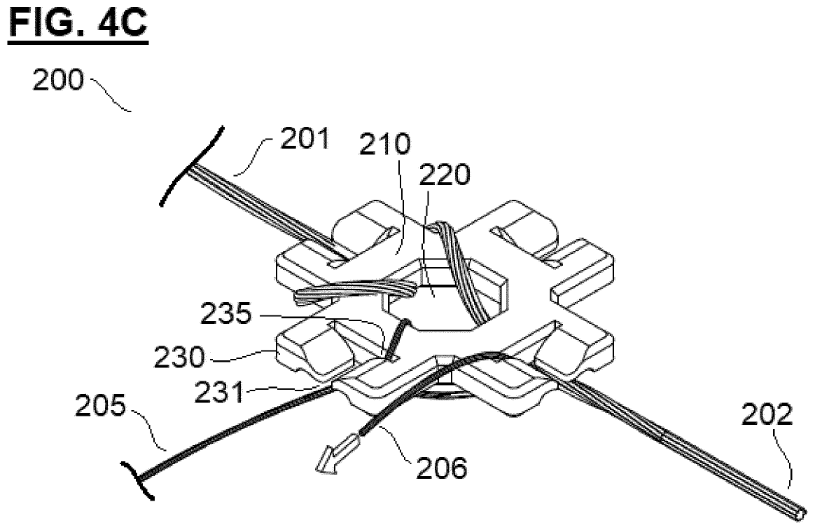

As seen in FIG. 4A, an exemplary method of using the present invention may comprise the steps of: providing a device 200 for connecting one or more securing lines, the device comprising a body 210 having a central passage 220 and a plurality of fastening members 230 arranged around a perimeter of the body 210; passing a distal end 202 of a first securing line 201 through the central passage 220; and engaging the first securing line 201 with a fastening member 230 (e.g., sliding the line 201 into a slot of the fastening member 230).

FIGS. 4B-4C shows an exemplary method of using the present invention further comprising the steps of: passing a distal end 202 of a first securing line 201 through the central passage 220, wrapping it around a fastening member 230, and passing it again through central passage 220; passing a distal end 206 of a second securing line 205 through the central passage 220, the second securing line 205 having a relatively small diameter (e.g., a diameter smaller than a diameter of the first securing line 201); engaging the second securing line 205 with a primary fastening slot 231 of a fastening member 230; determining if the width of the line 205 is too small to be properly secured in the primary fastening slot 231; and if so, adjusting the secondary securing line 205 to engage with a secondary fastening slot 235 of the fastening member 230 (e.g., sliding the line 205 from the primary fastening slot 231 into the secondary fastening slot 235 as shown in FIG. 4C). In some embodiments, the method may further comprise the step of wrapping the distal end 206 of the secondary securing line 205 around to engage with a secondary fastening slot of a second fastening member of the device 200 (also shown in FIG. 4C).

In other embodiments, a method of using the present invention may include the steps of: passing a distal end 206 of a securing line 205 having a relatively small diameter through the central passage 220; engaging the securing line 205 with a primary fastening slot 231 of a fastening member 230; determining if the width of the line 205 is too small to be properly secured in the primary fastening slot 231; and if so, adjusting the securing line 205 to engage with a secondary fastening slot 235 of the fastening member 230.

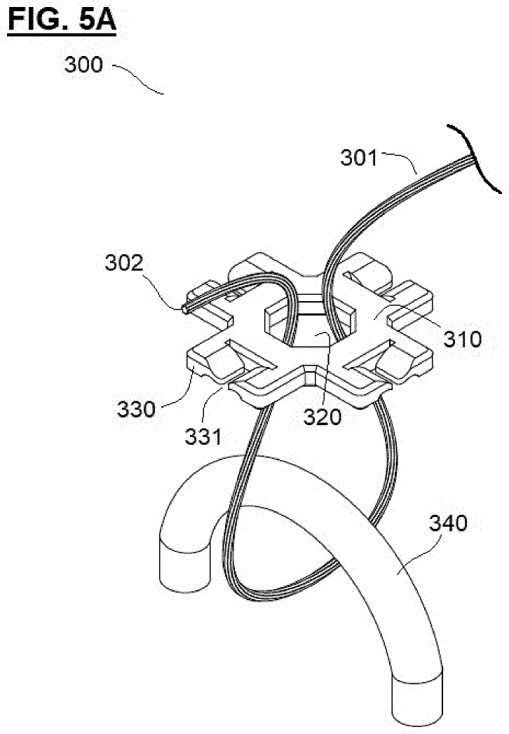

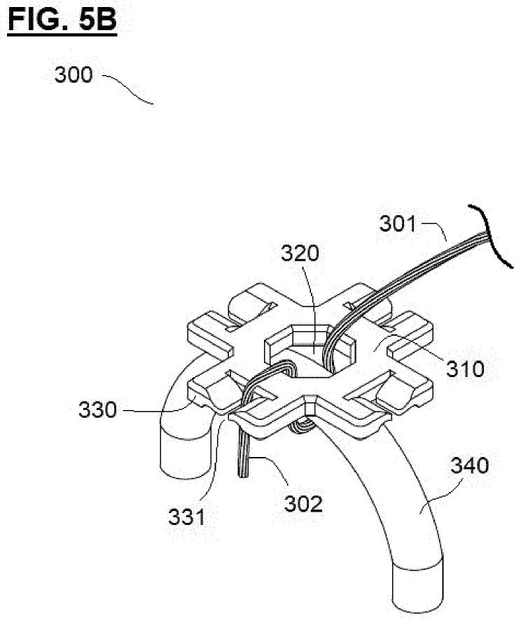

As seen in FIGS. 5A-5B, another exemplary method of using the present invention may comprise the steps of: providing a device 300 for connecting one or more securing lines, the device comprising a body 310 having a central passage 320 and a plurality of fastening members 330 arranged around a perimeter of the body 310; passing a distal end 302 of a securing line 301 through the central passage 320; wrapping the line 301 around a separate securing member 340 (e.g., a securing hook or loop in the bed of a truck, or on the deck of a ship); passing the distal end 302 back through the central passage 320; and engaging the line 301 with a fastening slot 331 of a fastening member 330.

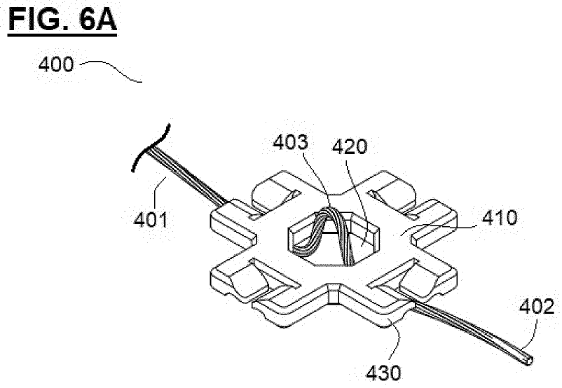

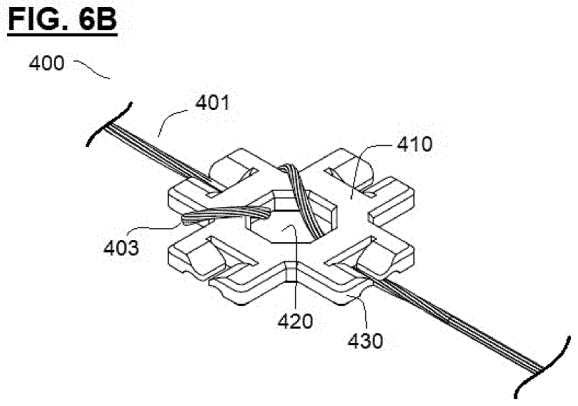

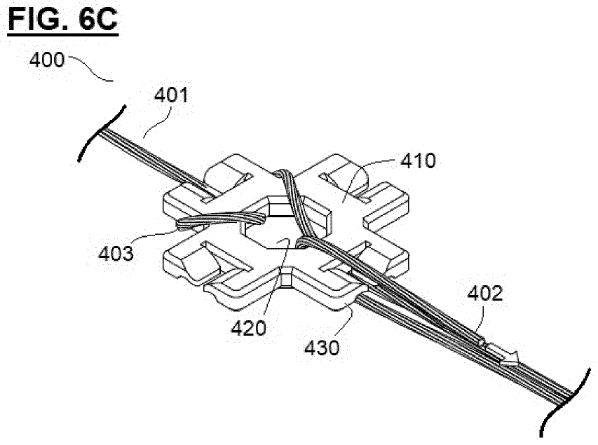

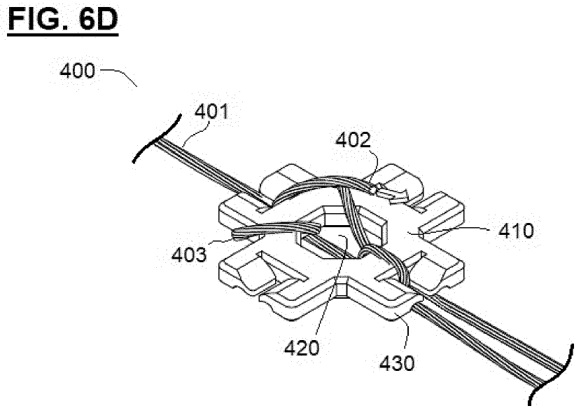

As seen in FIGS. 6A-6C, another exemplary method of using the present invention may comprise the steps of: providing a device 400 for connecting one or more securing lines, the device comprising a body 410 having a central passage 420 and a plurality of fastening members 430 arranged around a perimeter of the body 410; pulling a midpoint 403 of a securing line 401 through the central passage 420; wrapping the midpoint 403 of the line 401 around a fastening member of the plurality of fastening members 430; passing a distal end 402 of the line 401 though a separate securing member (not shown; e.g., a securing hook or loop in the bed of a truck, or on the deck of a ship, see FIG. 5A); passing the distal end 402 through the central passage 420; pulling on the distal end 402 to create tension in the line 401; and engaging the line 401 with a fastening member of the plurality of fastening members 430. As seen in FIG. 6D, the method may further include the step of wrapping the distal end 402 around the body 410 to engage with a second fastening member of the plurality of fastening members 430.

Another exemplary method of using the an embodiment of the invention to secure a line to an anchor point (such as truck tie-down, a tree, a hook, or the like) includes the steps of (1) threading one end of the line through the center hole of an embodiment of the invention, then around the anchor point, and then back through the center hole again; (2) then using a shorter end of the line, wedging it into a first fastening slot on the embodiment of the invention and then wedging it into a second slot on the embodiment (preferably on the opposite side); (3) then pulling the unsecured opposite end of the line rope to take up any slack near the anchor point (the device should now be up against the anchor point). To disengage the device, one need simply pull the short end of the rope out from both of the slots.

Another exemplary method of using an embodiment of the invention may create additional tension points or tie-down locations to help secure items (for example: on top, and in the center of a load that needs additional tension/pressure). In these methods, an existing line is already in place and anchored at both ends to secure items, but additional anchor points are needed to further secure the items. These methods add a new tie-down point/anchor point along an existing line. In these methods, one end of a second line is already anchored to an established anchor point. The first step (1) is to make a small loop in the existing line and thread the loop through the center opening of an embodiment of the invention; then (2) the loop is placed around the outside of one of the fastening members (not through the slot, but around the perimeter); then (3) while holding the embodiment in one hand (so the newly placed rope stays in place), the opposite/free end of the second line is threaded through the opening of the embodiment. Once this is done, the opposite end is (4) pulled pull away from the loop of the first line. The loop in the first line will hold the device in place while the second line is pulled in an opposite direction, helping to add tension to the entire system. Once the desired tension is achieved, (5) the opposite end is wedged into one of the fastening slots on the embodiment for securement. In some embodiments, the opposite end of the rope may (6) be wedged into a second slot on the embodiment (preferably opposite from the first wedge) to further secure the line to the device. To remove the device or to reset the tension simply pull on the slack line that is wedged into the device (held in place by one or both slots) and then begin adding tension to the system. Then pop the line back into one or both of the slots.

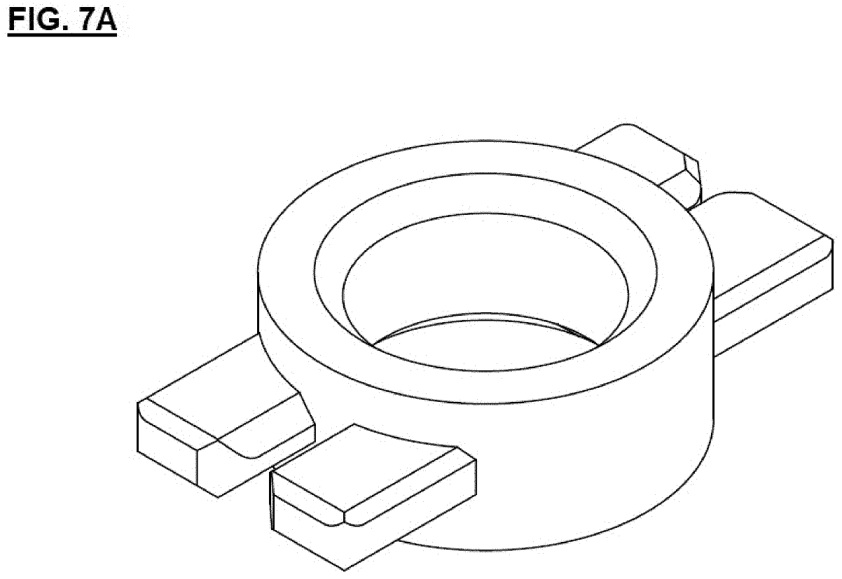

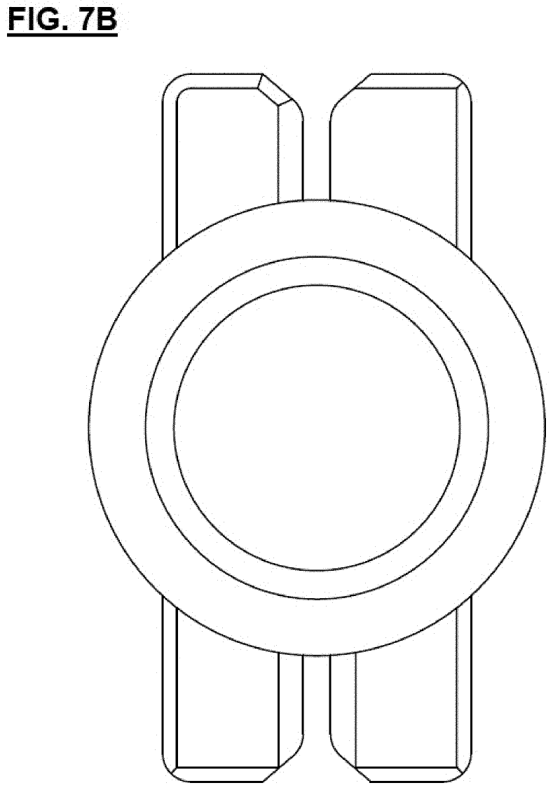

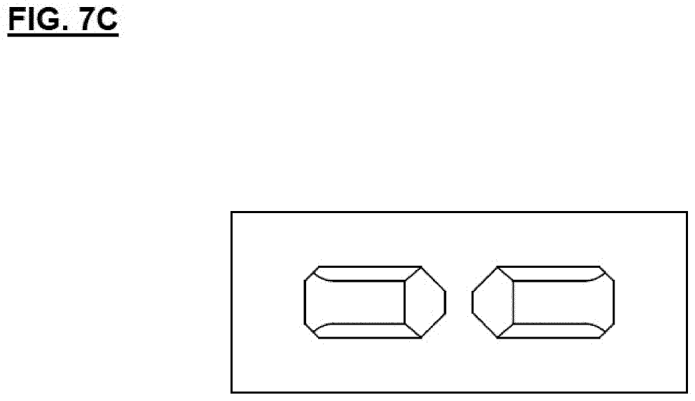

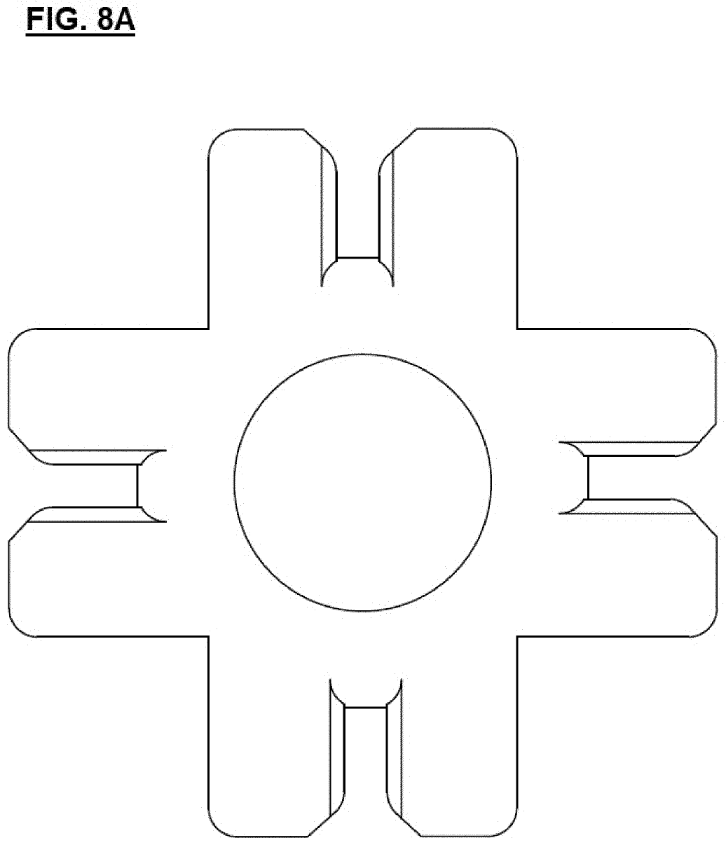

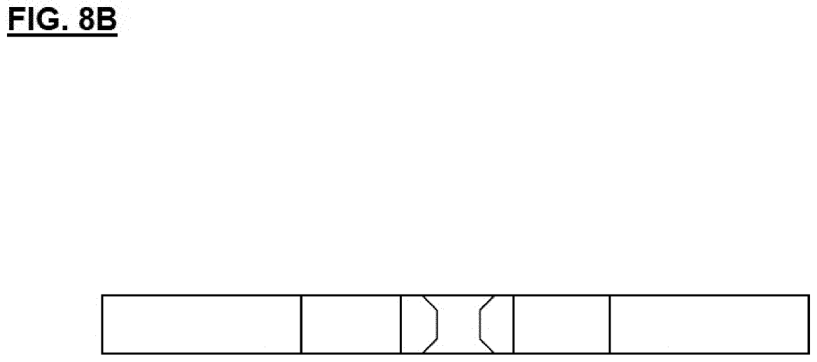

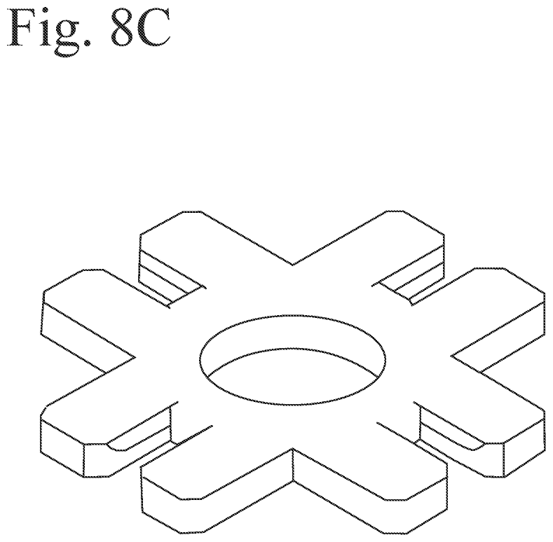

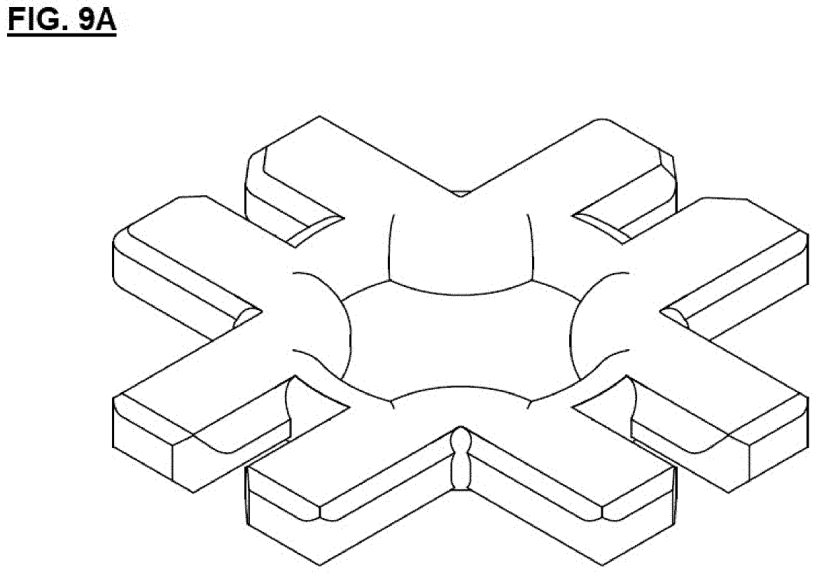

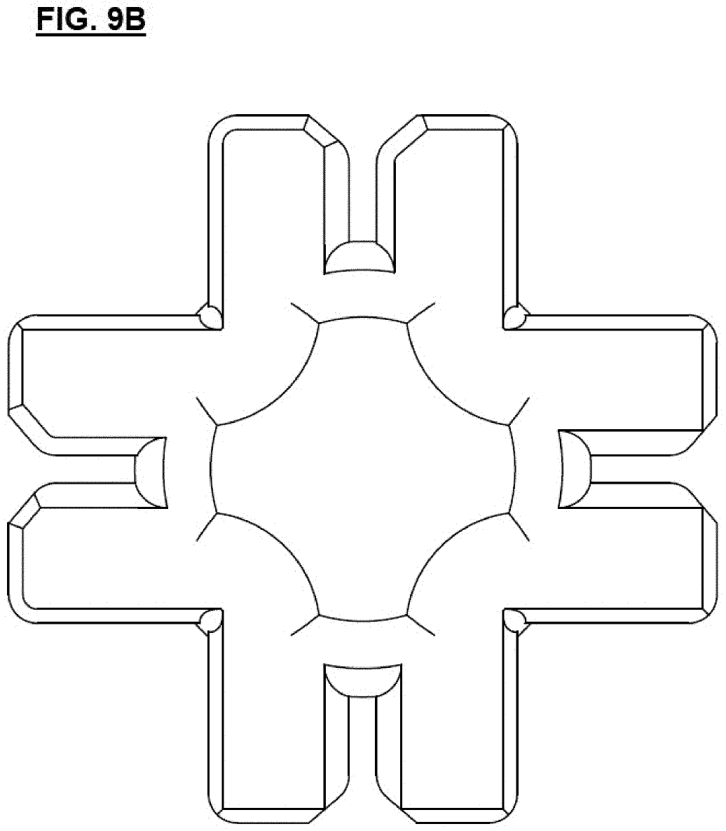

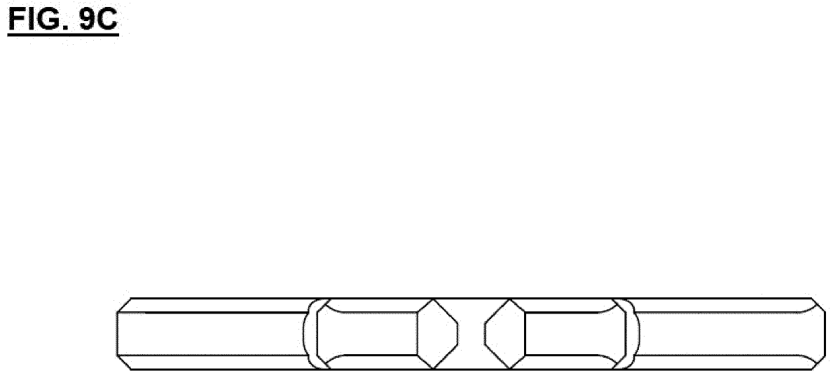

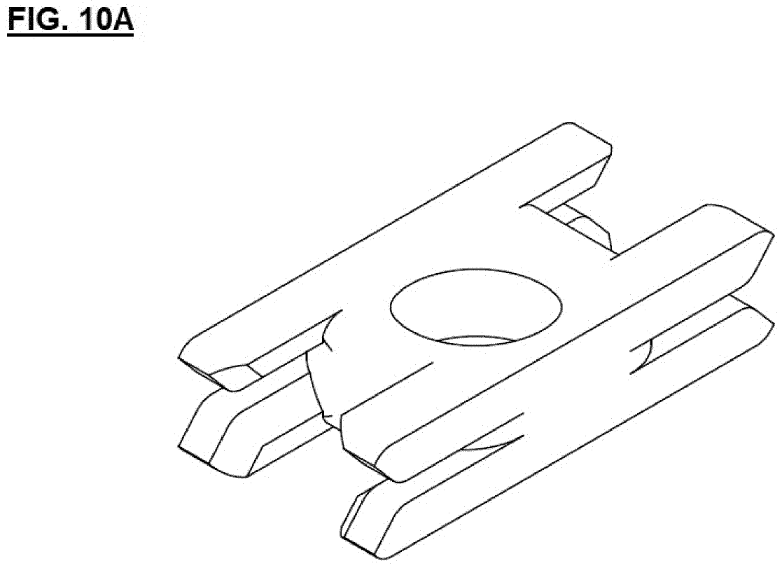

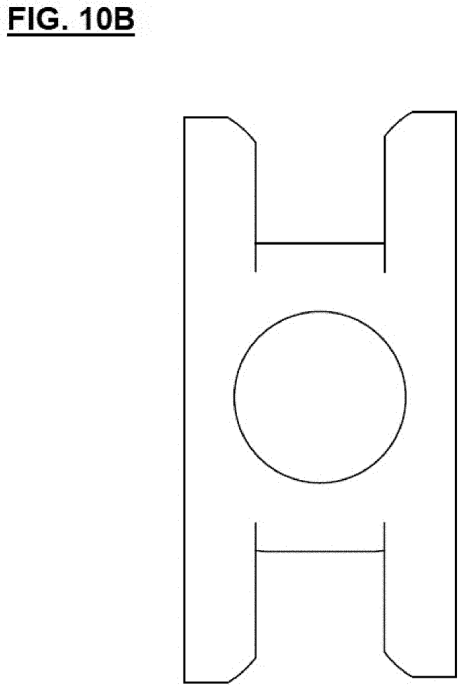

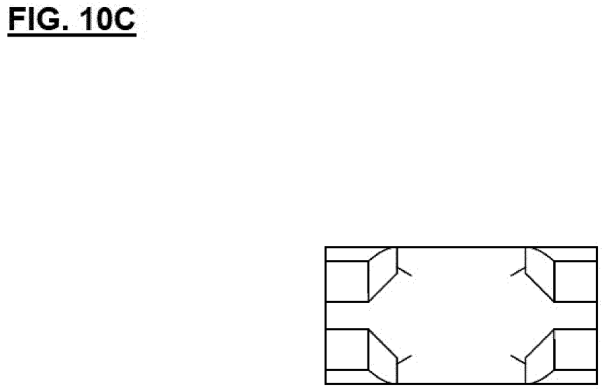

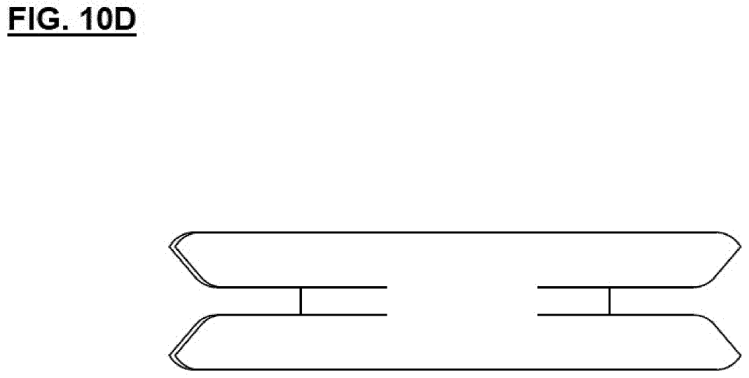

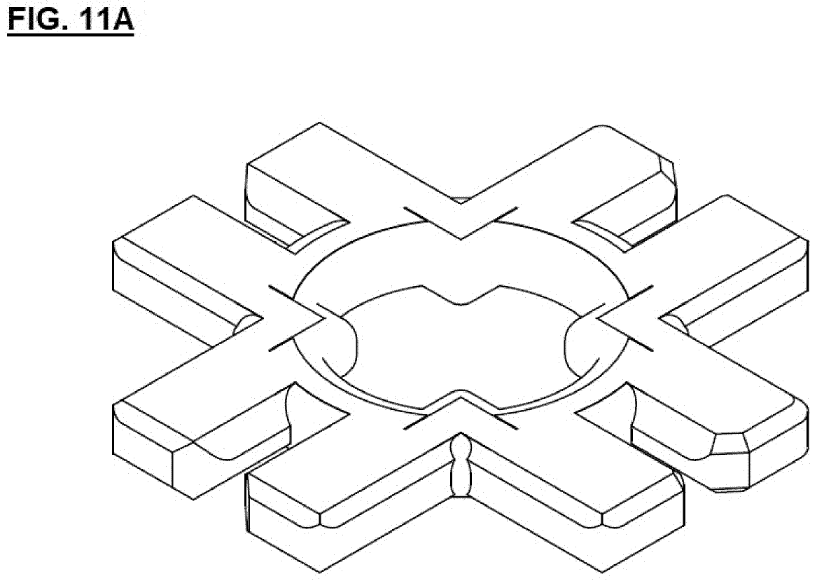

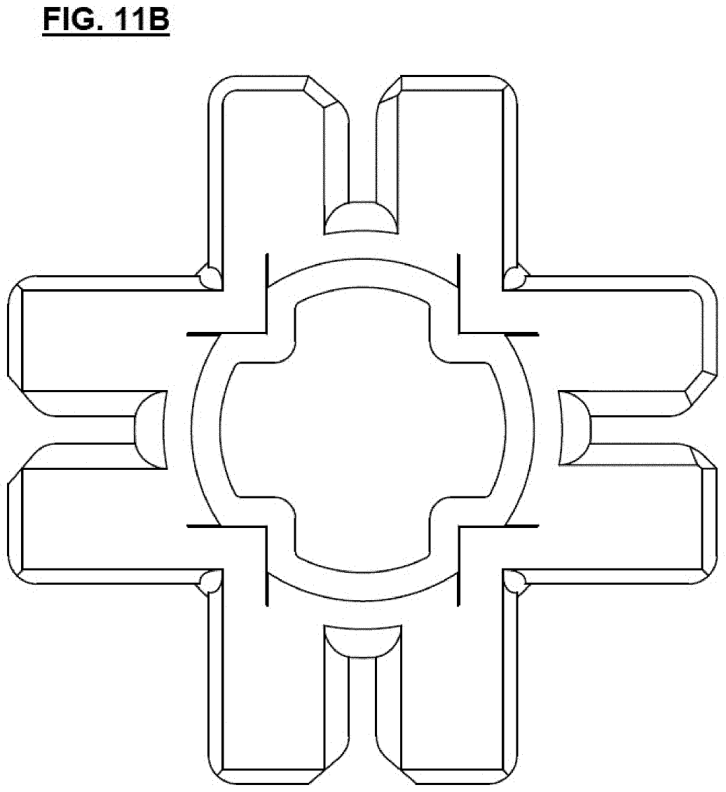

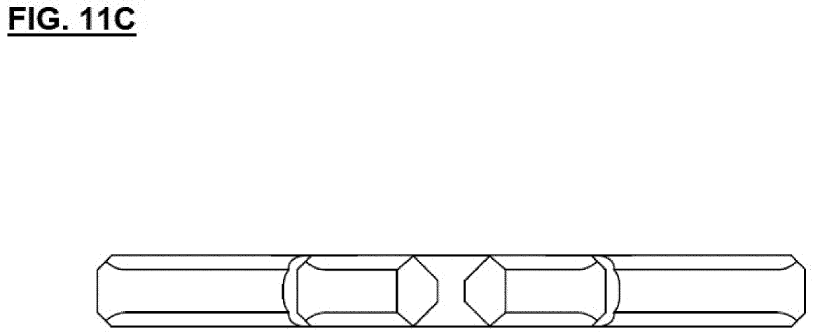

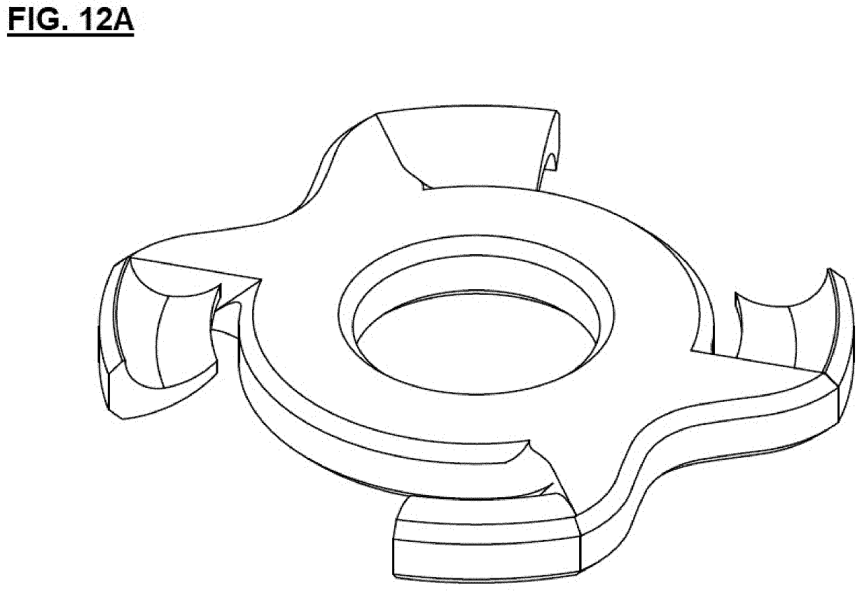

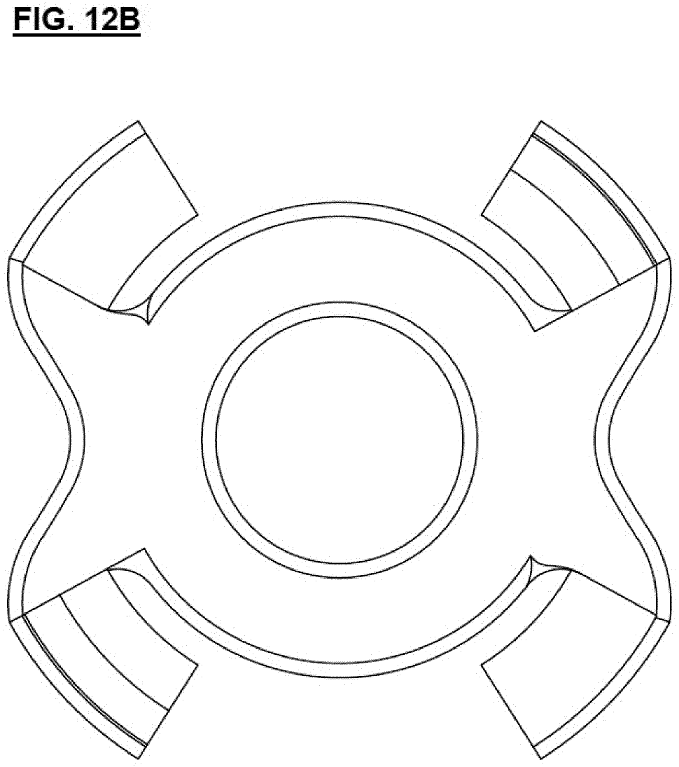

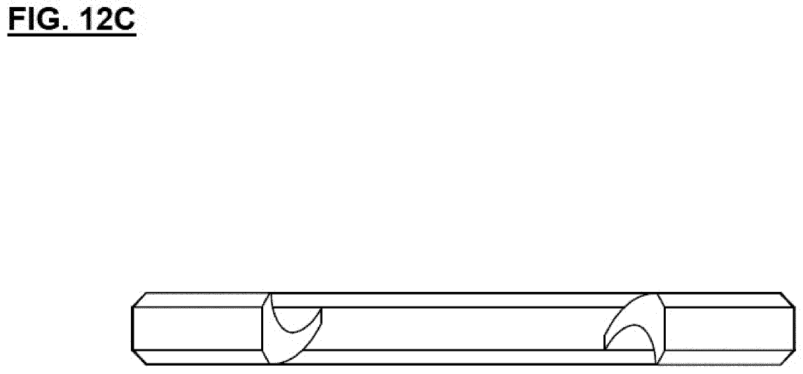

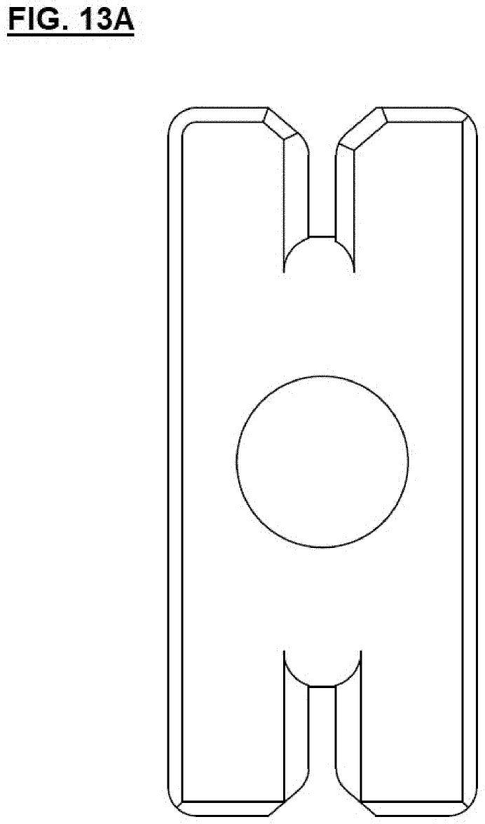

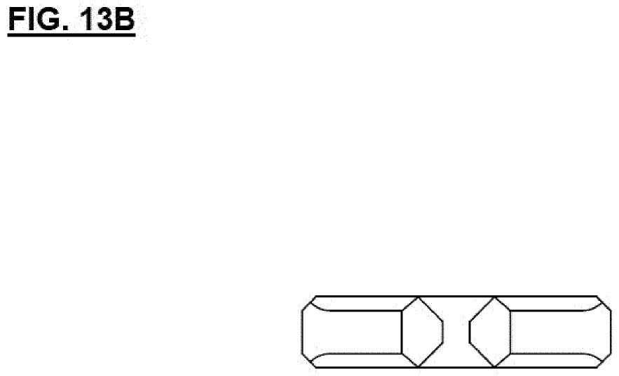

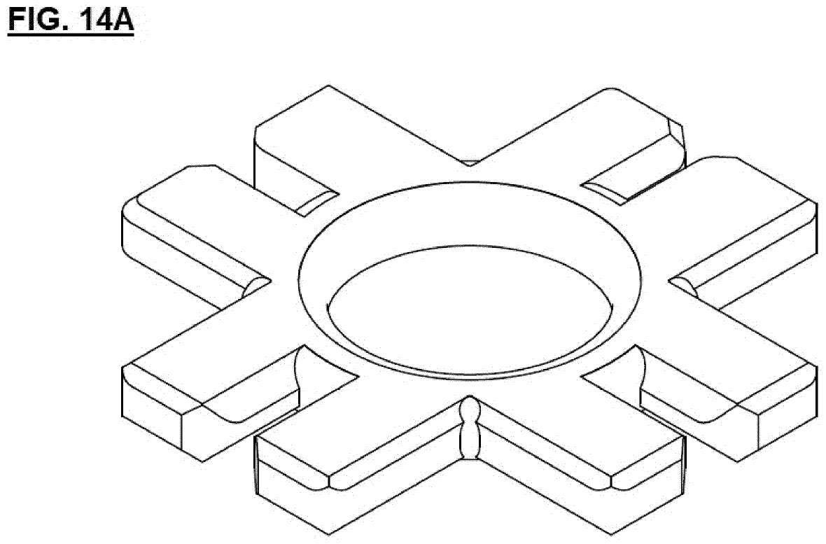

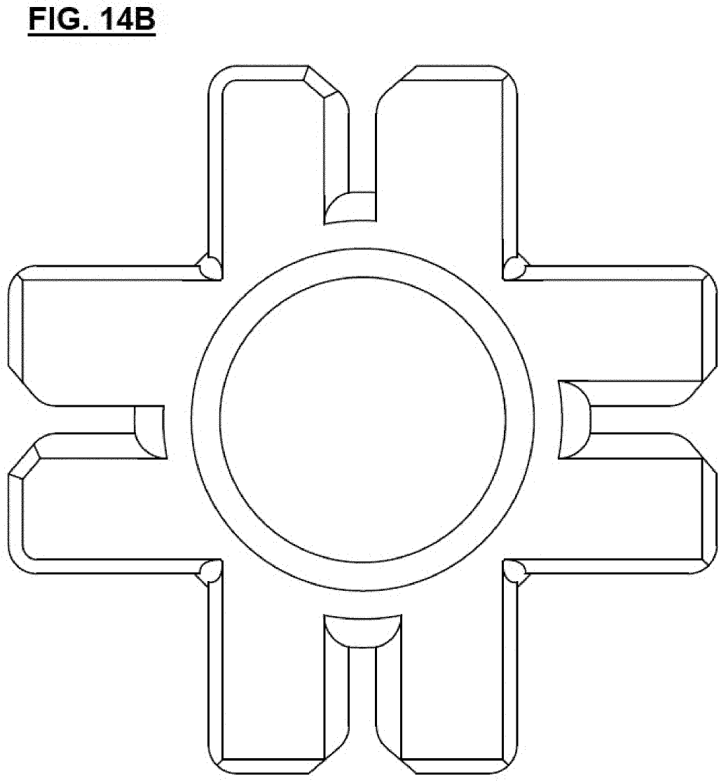

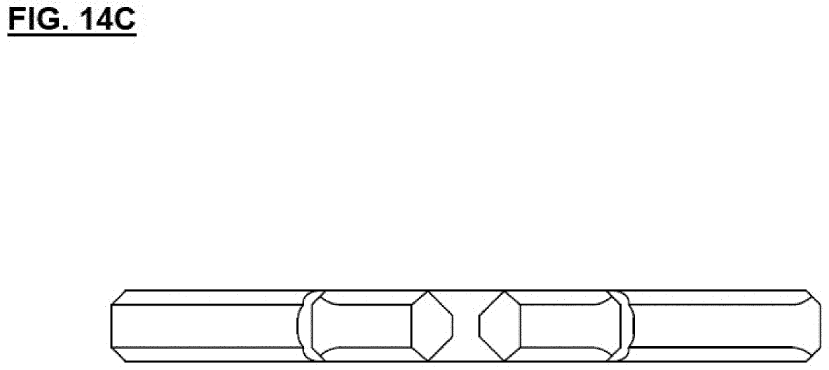

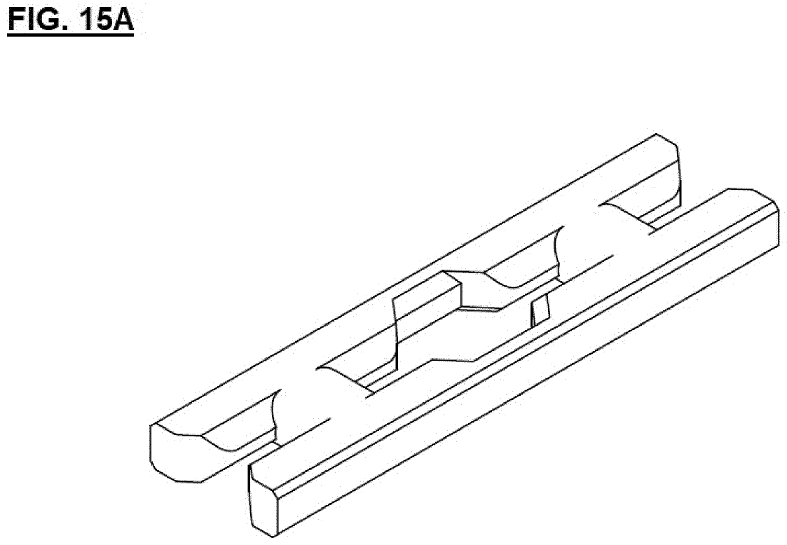

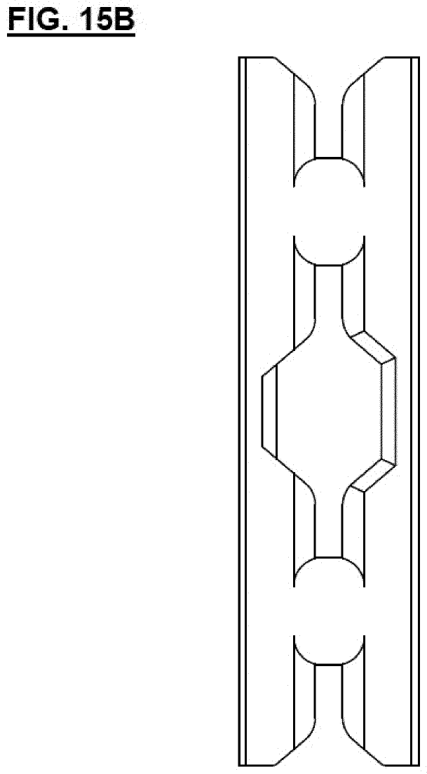

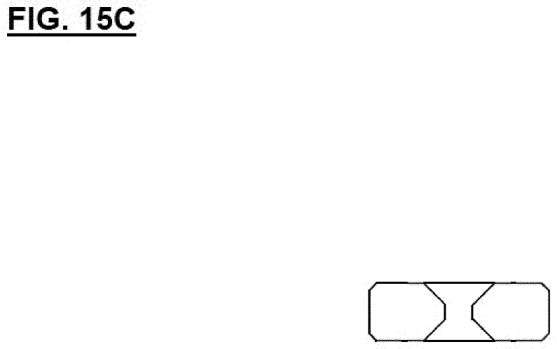

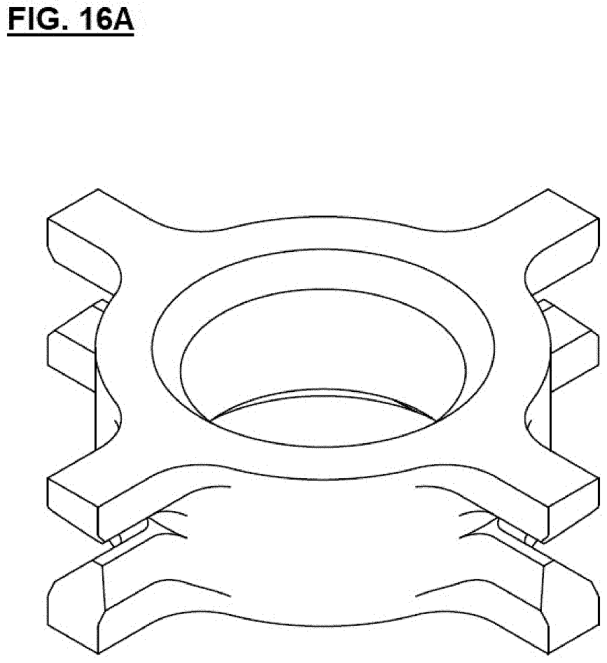

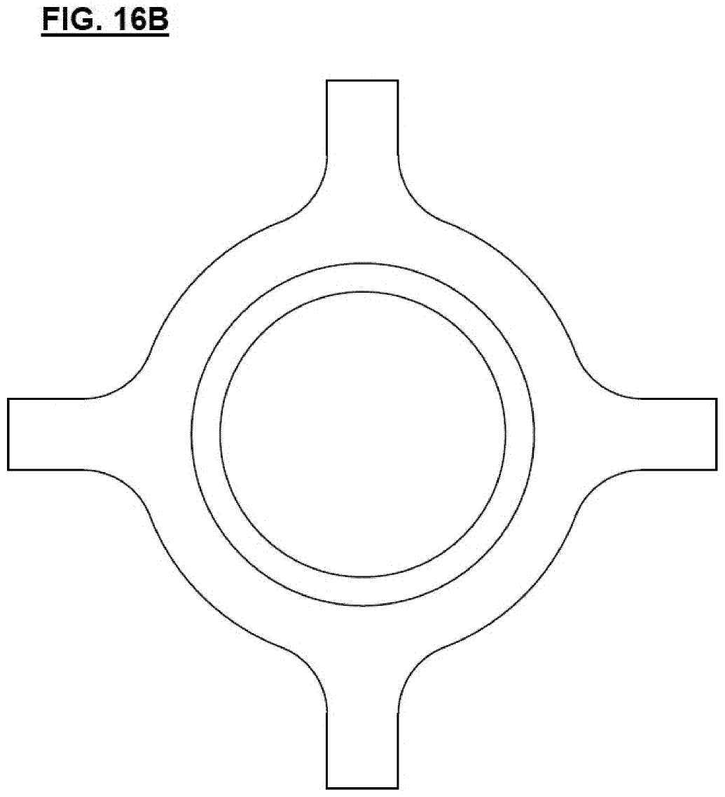

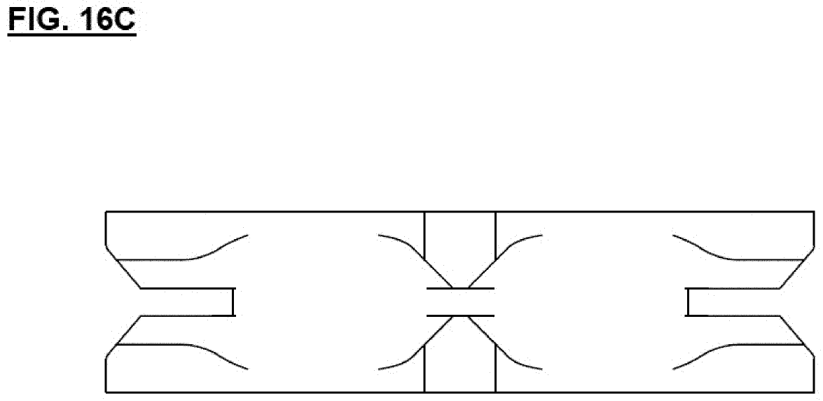

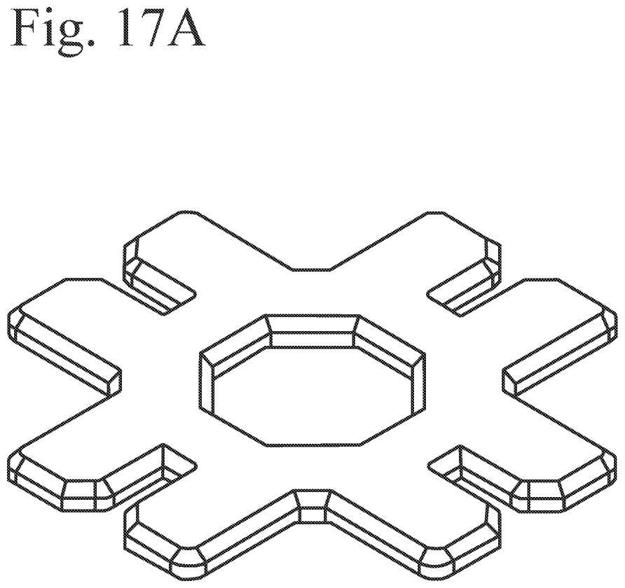

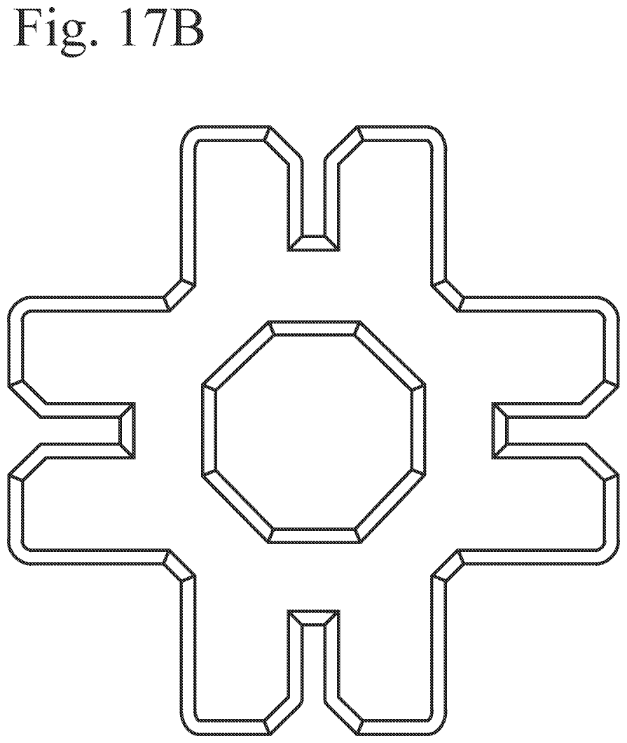

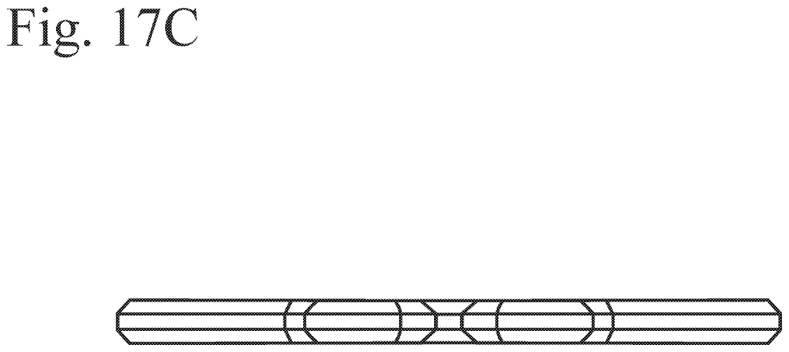

FIGS. 7A-7C, 8A-8B, 9A-9C, 10A-10D, 11A-11C, 12A-12C, 13A-13B, 14A-14C, 15A-15C, 16A-16C and 17A-C show various other shapes of devices of the present invention for connecting one or more securing lines, according to embodiments of the present invention.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

What is claimed is:

1. A device for connecting securing lines comprising a body having a central opening for receiving at least one securing line and a plurality of fastening members arranged around a perimeter of said body for engaging said at least one securing line, wherein each fastening member comprises a primary slot having two oppositely facing securing edges therein for receiving said at least one securing line between them.

2. The device of claim 1 wherein each of said securing edges is angled to resist movement of said at least one securing line in a first direction, and to allow for movement of said at least one securing line in an opposite direction.

3. The device of claim 2, wherein each primary slot has a width that corresponds to a diameter of one of said at least one securing lines.

4. The device of claim 2, wherein each of said plurality of fastening members further comprises at least one secondary slot branching off from said primary slot.

5. The device of claim 4, wherein said at least one secondary slot has a width that is smaller than a width of said primary slot, such that a securing line having a diameter too small to be secured in said primary slot may be secured in said secondary slot.

6. The device of claim 4, wherein said at least one secondary slot comprises two secondary slots branching off in opposite directions from said primary slot.

7. The device of claim 1, wherein said central opening comprises a plurality of sides, and wherein each of said plurality of fastening members is radially aligned with one of said sides.

8. The device of claim 1 wherein each of said sides is beveled.

9. The device of claim 2, wherein said body comprises a flat upper surface, a flat lower surface, and a narrow cross sectional area along a horizontal plane, wherein each of the securing edges of each slot comprises a lower surface that is generally parallel to said plane, and an upper surface that is angled with respect to said plane.

10. The device of claim 9, wherein each of said upper surfaces comprises an acute angle that acts as a barb to resist movement of said one or more securing lines in a first longitudinal direction, but allows for movement of said one or more securing lines in a second longitudinal direction.

11. The device of claim 2, wherein said body comprises a disk having a substantially polygonal shape, and said plurality of fastening members comprise four fastening members arranged evenly about a perimeter of said body.

12. A method of connecting a plurality of securing lines comprising the steps of:
a. passing a first securing line through a central opening in a device comprising a body having a central opening therein and a plurality of fastening members arranged around a perimeter of said body, wherein each fastening member comprises a slot having two oppositely facing securing edges therein for receiving a securing line between them;
b. engaging said first securing line with a slot of one of said fastening members;
c. passing a second securing line through said central opening; and
d. engaging said second securing line with a slot of a different one of said fastening members.

13. The method of claim 12 comprising the additional steps of:
a. passing said first securing line back through said central opening; and
b. passing said second securing line back through said central opening.

14. The method of claim 12 comprising the additional steps of:
a. wrapping said first securing line around one of said fastening members;
b. then passing said wrapped first securing line back through said central opening;
c. wrapping said second securing line around one of said fastening members; and
d. then passing said wrapped second securing line back through said central opening.

15. A method of securing a line to an object comprising the steps of:
a. passing a securing line through a central opening in a device comprising a body having a central opening therein and a plurality of fastening members arranged around a perimeter of said body, wherein each fastening member comprises a slot having two oppositely facing securing edges therein for receiving a securing line between them;
b. passing a distal end of said securing line though an opening on said object;
c. passing said distal end of said securing line from said object back through said central opening of said body;
d. engaging said distal end of said securing line with a slot of one of said plurality of fastening members;
e. engaging said distal end of said securing line with a slot of a different fastening member of said plurality of fastening members;
f. pulling a proximal end of said securing line to take up slack in said line between said object and said device.

16. The method of claim 15 comprising the additional step of engaging said proximal end of said securing line with a slot of a third fastening member of said plurality of fastening members.

17. The method of claim 16 comprising the additional step of engaging said proximal end of said securing line with a slot of a fourth fastening member of said plurality of fastening members.

18. A method of connecting securing lines comprising the steps of:
a. anchoring opposite ends of a first securing line to at least one object;
b. creating a loop in said first securing line, and pulling said loop through a central opening of a device comprising a body having a central opening therein and a plurality of fastening members arranged around a perimeter of said body, wherein each fastening member comprises a slot having two oppositely facing securing edges therein for receiving a securing line between them;
c. wrapping said loop around one of said fastening members;
d. anchoring one end of a second securing line to at least one object;
e. passing an opposite end of said second securing line through said central opening of said device;
e. pulling said opposite end of said second securing line to create tension; and
f. engaging said opposite end of said second securing line with a slot of one of said plurality of fastening members.

19. The method of claim 18 comprising the additional step of engaging said opposite end of said second securing line with a slot of a different fastening member of said plurality of fastening members.
